(19) United States
(12) Patent Application Publication
(10) Pub. No.: US 2021/0400210 A1
(43) Pub. Date: Dec. 23, 2021

(54) INFRARED WIDE-ANGLE CAMERA

(71) Applicant: ImmerVision, Inc., Montreal (CA)

(72) Inventors: Simon THIBAULT, Quebec City (CA); Jocelyn PARENT, Montreal (CA); Patrice ROULET, Montreal (CA); Pascale NINI, Montreal (CA)

(21) Appl. No.: 17/355,741

(22) Filed: Jun. 23, 2021

Related U.S. Application Data
(60) Provisional application No. 63/042,810, filed on Jun. 23, 2020.

(51) Int. Cl. H04N 5/33; H04N 5/232

(52) U.S. Cl. CPC H04N 5/33; H04N 5/23229; H04N 5/232935

(57) ABSTRACT

A method for enhancing IR wide-angle camera measurement accuracy by using object distance information. The method is based on using the high-resolution information from a visible camera as part of the same imager as the IR camera. A processor is then used to estimate with a processing algorithm the distance to an object and use the estimated distance to provide more accurate IR results after calibrating the result based on the estimated distance.

### CROSS-REFERENCE TO RELATED APPLICATIONS

The present application claims the benefit of U.S. Provisional Patent Application No. 63/042,810, filed on Jun. 23, 2020, entitled “Infrared wide-angle camera,” currently pending, the entire contents of which are incorporated by reference herein.

### BACKGROUND OF THE INVENTION

Embodiments of the present invention relate to the field of infrared (IR) imaging and more specifically how to enhance the infrared camera measurement accuracy with the help of additional scene information.

The accuracy of IR imaging depends greatly on how accurate the calibration is. This is especially true for Long Wavelength Infrared (LWIR) applications in which the measurement from the camera can be converted to a temperature output. The more precisely we can know the distance between the IR camera and the object of interest, the more precise the temperature measurement will be.

Some existing IR cameras are pre-calibrated precisely during manufacturing to give the most precise measurements. However, calibrating every single camera become problematic if a large scale/low-cost mass production is required, as is often the case with a consumer electronic application.

Existing depth analysis methods, like the use of a time-of-flight sensor, emitting and analyzing back structured light, or stereoscopic imaging, are sometime used to evaluate the depth of objects of interest in the scene, but the additional light sources, cameras or sensors required are often not practical, especially for a consumer electronic application where the price and dimension of the IR camera are crucial.

Furthermore, these existing depth analysis methods are generally limited in field-of-view or object distance, either because emitting a time-of-flight signal or a structured light signal over a large field of view and long distance require too much signal power or because stereoscopic vision systems are unable to measure a difference of parallax for objects located at a large field angle compared to their optical axis because the projected difference of viewpoint between stereoscopic cameras in the direction perpendicular to this large field angle become smaller and smaller with increasing field angle until it becomes null at a field angle of 90°.

For all of these reasons, there is a need for a new method to enhance the accuracy of IR wide-angle camera measurements.

### BRIEF SUMMARY OF THE INVENTION

To overcome all the previously mentioned issues, embodiments of the present invention present a novel method in which processing the information from both an IR camera and a visible camera of an imager improves the measurements from the imager. A scene is imaged by an imager having at least two cameras, a visible camera creating a digital image with visible scene information and an infrared camera creating a digital image with infrared scene information, both generally attached to an optical system. The IR camera generally has a lower resolution compared to the visible camera. In a preferred embodiment according to the present invention, the IR camera and its optical system are in the Long Wavelength Infrared (LWIR) waveband often defined as wavelengths between 8 μm and 14 μm, but the IR camera and its optical system could also be used in any another band of the IR light spectrum according to the present invention. The output images from the imager are then processed by a processor. In a preferred embodiment according to the present invention, the processing uses the high-resolution image from the visible camera to calculate the depth of the various objects in the scene in order to improve the depth calibration required by the IR camera. To calculate the depth of each object in the scene, one of the digital image with infrared scene information or the digital image with visible scene information is processed by a neural network algorithm previously trained to estimate the depth of objects from a single wide-angle image using artificial intelligence training techniques. Using the depth information calculated, the processor adjusts the resulting thermal information from the measured signal captured by the IR camera. The resulting calculated temperature of the scene by the IR camera is hence more accurate because of the depth calibration of the IR camera using the results from the neural network.

In other embodiments, it is the lower resolution output from the IR camera that is used to improve the processing of the high-resolution image from the visible camera, for example by giving temperature information of various objects to help a segmentation processing or any other type of processing done on the visible image.

In other embodiments, the imager creates at least one image with on-purpose distortion in order to increase the number of pixels in a zone of interest, allowing further improvement in the accuracy of the IR camera measurements.

In other embodiments, the high-resolution information from the visible camera is used to complete the low-resolution information of the IR camera, allowing to output IR measurements with a resolution higher than the resolution of the IR camera itself.

### BRIEF DESCRIPTION OF THE SEVERAL VIEWS OF THE DRAWINGS

The foregoing summary, as well as the following detailed description of a preferred embodiment of the invention, will be better understood when read in conjunction with the appended drawings. For the purpose of illustration, there is shown in the drawings an embodiment which is presently preferred. It should be understood, however, that the invention is not limited to the precise arrangements and instrumentalities shown.

In the drawings:

FIG. 1 shows a method in which processing the information from both the IR camera and the visible camera of the imager improves the output; and

FIG. 2 shows a method in which the imager adds on-purpose image distortion before processing the information from both the IR camera and the visible camera of the imager to further improve the output.

### DETAILED DESCRIPTION OF THE INVENTION

The words “a” and “an”, as used in the claims and in the corresponding portions of the specification, mean “at least one.”

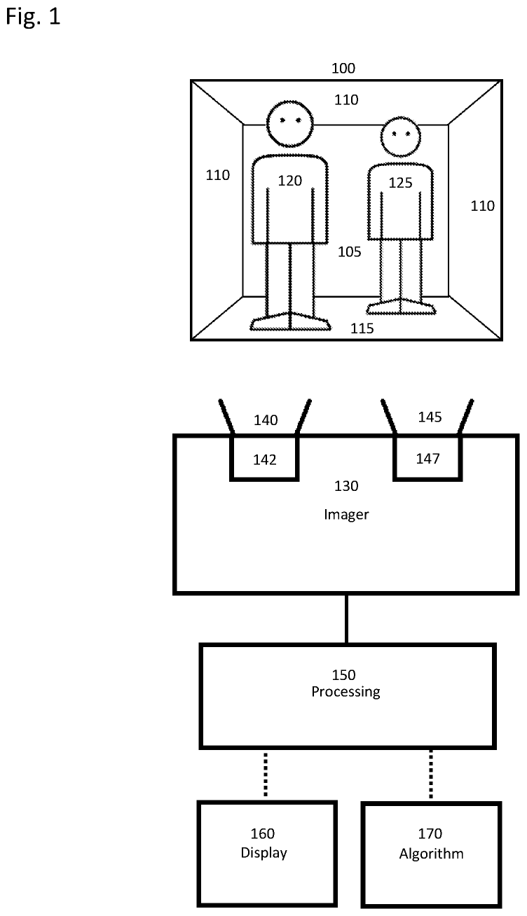

FIG. 1 shows a preferred embodiment of the method in which processing the information from both the IR camera and the visible camera of an imager improves the output according to the current invention. In this example, the object includes an indoor scene 100 having a background wall 105, some walls and ceiling 110 and a floor 115. In the scene, there are two humans located at a different distance from an imager. The human 120 is located closer to the imager and the human 125 is located farther from the imager as can be determined by the location of their feet on the floor 115. The scene is imaged by an imager 130 configured to capture a scene and create digital image files. The imager 130 includes an infrared camera creating a digital image with infrared scene information, a visible camera creating a digital image with visible scene information and a processor configured to process one of the digital image with infrared scene information or the digital image with visible scene information. In a preferred embodiment according to the present invention, the imager is any electronic device in which the at least two cameras 142 and 147 are part of, including, but not limited to, a mobile phone, a tablet, a computer, a standalone camera, a robot, a drone or the like. In some other embodiments according to the present invention, the imager could encompass the IR camera and the visible camera as part of two separate electronic devices and their outputs are then combined at the processing step 150, but generally both the infrared camera and the visible camera are located on one physical device. The camera 142 includes an IR (Infrared) image sensor generally having a lower resolution compared to visible camera 147 because the pixels in this waveband are generally bigger than the pixels for visible applications. The camera creates a digital image with IR scene information. A wide-angle IR optical system 140 is attached to the camera 142. The wide-angle IR optical system 140 is generally made of a combination of any number of lens elements made of material able to refract the IR light and/or mirror elements made of material able to reflect the IR light. The wide-angle IR optical system 140 creates an optical image in an image plane located on the image sensor of the camera 142. In a preferred embodiment according to the present invention, the camera 142 and the optical system 140 are used in the LWIR (Long Wavelength Infrared) waveband, but the camera and optical system could also be in another band of the IR light spectrum, including the near-infrared (NIR), the short-wavelength infrared (SWIR), the mid-wavelength infrared (MWIR), the far infrared (FIR) or any partial or complete combination of these IR wavebands. The camera 147 includes a visible sensor generally having a higher resolution compared to camera 142 because the pixels in this waveband are generally smaller than the pixels for IR applications. The camera 147 creates a digital image with visible scene information. A wide-angle visible optical system 145 is attached to the camera 147. In some embodiments according to the present invention, the digital image with visible scene information has a higher number of pixels than the digital image with infrared scene information. In some other embodiments, additional information from the higher number of pixels from the digital image with visible scene information is used by the processor to modify the digital image with infrared scene information. The wide-angle visible optical system 145 is generally made of a combination of any number of lens elements made of material able to refract the visible light and/or mirror elements made of material able to reflect the visible light. The wide-angle visible optical system 145 creates an optical image in an image plane located on the image sensor of the camera 147. In other embodiments according to the present invention, the optical system 145 could also include at least a diffractive surface, a meta-surface or other type of optical surface helping to form an image on the image sensor. The field of view of both the wide-angle IR optical system 140 and the wide-angle visible optical system 145 can be identical or different depending on the application. Here, for both optical systems, the term wide-angle is understood to mean an optical system having a full diagonal field of view of generally more than 80°. In a preferred embodiment, the field of view of the infrared camera and the field of view of the visible camera are both greater than 80°. In other embodiments according to the present invention, the imager can also use even wider fields of view, like over 120° or even a field of view over 150°, depending on the application. The images from the imager 130 are then processed at the processing step 150. The processing by the processor of the one of the digital image with infrared scene information or the digital image with visible scene information is used by the processor to modify an output from the imager related to the other of the digital image with infrared scene information or the digital image with visible scene information. This processing step can be done with any kind of processor able to execute software algorithms or hardware operations, including, but in no way limited to, a central processing unit (CPU), a graphical processing unit (GPU), a tensor processing unit (TPU), an application-specific integrated circuit (ASIC), a field-programmable gate array (FPGA) or any other unit able to perform processing operations. This processing step can either be done inside the same device as the imager or in a separate device. In some embodiments according to the present invention, the processing by the processor uses one of the high-resolution digital image with visible scene information from the visible camera 147 or the low-resolution digital image with IR scene information from the IR camera 142 to calculate the distance or depth of the various objects in the scene from the imager, in this example the person 120 and the person 125. To calculate the depth of each object in the scene, the high-resolution visible image is generally processed by a neural network algorithm previously trained to estimate the depth of object from a single wide-angle image using artificial intelligence training techniques. The neural network could also be trained directly using both visible images and IR images so that it can automatically process both at the same time to generate the output. The neural network can be of any kind, including a neural network using some convolution operations to process the input image and to output a depth map. In a preferred embodiment, only the visible image is used by the neural network to calculate the depth, in part because of its higher resolution. In some alternate embodiments, the low-resolution image from the IR camera could instead be used or the images from both cameras could be used. In the example of FIG. 1, the result from the depth analysis by the neural network is that the person 120 is closer to the imager 130 and the person 125 is farther from the imager 130. Using the calculated distance, the processing step 150 modifies the resulting output temperature information of objects from the measured signal captured by the IR camera 142. The resulting calculated temperature of the scene, including of person 120 and person 125 is hence more accurate because the depth calibration of the IR signal is possible at the processing step. After the processing step 150, the resulting modified output of the scene is optionally displayed on a display for a human observer at step 160 or used by a further algorithm 170 using the resulting calculated temperatures for any further application.

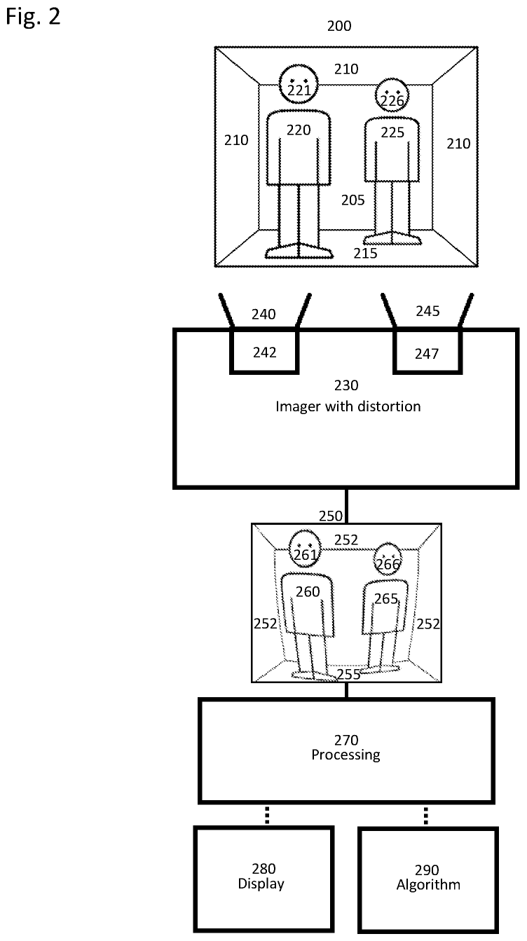

FIG. 2 shows an alternate embodiment of the method in which the imager adds on-purpose image distortion before processing the information from both the IR camera and the visible camera of the imager to further improve the output according to the current invention. In this example, the object is the same as in FIG. 1 and still includes an indoor scene 200 having a background wall 205, some walls and ceiling 210 and a floor 215. In the scene, there are two humans located at different distances from an imager. The human 220 is located closer and the human 225 is located farther, as can be determined by the location of their feet on the floor 215. The scene is imaged by an imager with distortion 230. Again, the imager 230 is any electronic device in which the at least two cameras 242 and 247 are part of, including, but not limited to, a mobile phone, a tablet, a computer, a standalone camera, a robot, a drone or the likes. In some other embodiments according to the present invention, the imager 230 could include the IR camera and the visible camera as part of two separate electronic devices and their output is then combined at the processing step 270. The camera 242 includes an IR (Infrared) image sensor generally having a lower resolution compared to visible camera 247 because the pixels in this waveband are generally bigger than the pixels for visible applications. A wide-angle IR optical system 240 is attached to the camera 242. The wide-angle IR optical system 240 is generally made of a combination of any number of lens elements made of material able to refract the IR light and/or mirror elements made of material able to reflect the IR light. The wide-angle IR optical system 240 creates an optical image in an image plane located on the image sensor of the camera 242. A wide-angle visible optical system 245 is attached to the camera 247. The wide-angle visible optical system 245 is generally made of a combination of any number of lens elements made of material able to refract the visible light and/or mirror elements made of material able to reflect the visible light. The wide-angle visible optical system 245 creates an optical image in an image plane located on the image sensor of the camera 247. In other embodiments according to the present invention, the optical system 245 could also include at least a diffractive surface, a meta-surface or other type of optical surface helping to form an image on the image sensor. In this example of FIG. 2, the imager 230 adds on-purpose distortion to at least one of the digital image with infrared scene information or the digital image with visible scene information, represented with the example image 250, to create at least one zone of interest with an increased number of pixels. In this example distorted image 250, the zone of interest is located toward the faces 261 and 266 of the people 260 and 265 in order to more accurately measure their face temperature, for example to detect if they have a normal body temperature related to a fever, a feeling, a behavior or any other reason that needs to be identified according to the application. By increasing the number of pixels in the zone of interest, the distortion generally decreases the number of pixels in other parts of the image, here the walls and ceiling 252 or the floor 255. The source of the distortion is generally from the optical system itself. In that case, the distortion can be barrel, pincushion or following any other custom distortion curve. In some embodiments, the distortion created by the imager can also be created by the camera using smart binning of the pixels or by further processing inside the imager to transform the image distortion from the captured image to the output image. The distortion is generally rotationally symmetric around the optical axis of the optical system creating the image, but this is not always the case and the distortion can be without symmetry according to the present invention. For example, the distorted image 250 of FIG. 2 is not symmetrical around the center of the image and more pixels are located in the zone of interest for this particular application, that is around the faces 261, 266 of the people 260, 265 in the image 250. In other embodiments, the distortion from the optical system could be rotationally symmetrical around its optical axis, but the optical axis of the optical system could be off-centered with respect to the center of the image in order to create an image with asymmetrical distortion. This on-purpose distortion in the distorted image from the imager is generally static, created often with the use of a non-spherical optical element, including, but not limited to, conic, aspherical, polynomial, freeform or the likes. In some other embodiments, the distortion in the distorted image is dynamic and can vary in time, either by using active optical elements in the optical system, by changing the smart binning in the imager, by changing the further processing done in the imager or by any other way allowing to dynamically change the distortion in the output image. In the example of FIG. 2, only one output image is shown for simplicity, but the distorted output image from the imager 230 could be either just for the image from the IR camera 242, just for the image from the visible camera 247, but generally both images have on-purpose distortion. The output images from the imager 230 are then processed at the processing step 270. In some embodiments according to the present invention, the processing uses the high-resolution image from the visible camera 247 to calculate the depth of the various objects in the scene, in this example the person 220 and the person 225. With the on-purpose added distortion, there are even more pixels on the object of interest, allowing even more accurate depth calculation. In some embodiments according to the present invention, the number of pixels in the image per unit of degree in the object scene in the zone of interest is at least 10% higher in the distorted image than it would be in an undistorted image. In some other embodiments, the increase in the zone of interest of pixels per degree is at least 20% or even at least 50% higher than in the undistorted image. To calculate the depth of each object in the scene, the high-resolution visible image is processed by a neural network algorithm previously trained to estimate the depth of object from a single wide-angle image using artificial intelligence training techniques. The neural network can also be trained specifically to process distorted images as outputted by the imager. In the example of FIG. 2, the result from the depth analysis from the neural network is that the person 220 is closer to the imager 230 and the person 225 is farther from the imager 230. Using the depth information calculated even more precisely using the on-purpose distortion, the processing step 270 adjusts the resulting thermal information from the measured signal captured by the IR camera 242. The resulting calculated temperature of the scene, including of person 220 and person 225 is hence more accurate because the depth calibration of the IR signal is possible at the processing step. The processing step 270 can also include other image processing to enhance the images, including dewarping to correct at least partially the distortion of the original images. After the processing step 270, the resulting calculated temperature of the scene is optionally displayed to a human observer at step 280 or used by a further algorithm 290 using the resulting calculated temperatures for any further application. In some embodiments according to the present invention, the distortion profile of the optical IR optical system 240 and the distortion profile of the visible optical system 245 are matching to allow perfect fusion of the IR and visible images.

In all of the above embodiments, the at least two cameras can be calibrated together using a visible and IR calibration target. This calibration with a common target allows for better correspondence between the IR and visible information, improving the accuracy of the processing. For example, the visible and IR calibration target could include a chessboard pattern that is made of two materials that respectively appear black and white in the visible spectrum and with one of the two materials that reflect or emit IR radiation in the desired IR spectrum band while the other does not in order to create a common chessboard in both the visible and IR band. This common calibration of the cameras using a common target can be done with a target at several distances and several field angle position in the images and the corresponding processing can adjust automatically its parameters based on the position in the field of view and the estimated distance of the object according to the method of the present invention.

In all of the above embodiments, the high-resolution visible image can be used to increase the resolution of the IR image and the resulting temperature measurements using any kind of processing to combine the high-resolution and low-resolution information, including, but not limited to, the use of a processing algorithm using artificial intelligence neural network. This allows output of IR measurements with a resolution (number of output pixels) higher than the original resolution of the IR camera.

In other embodiments, it is the infrared scene information from the digital image file with IR scene information that is used to modify the processing of the digital image with visible scene information, for example by giving temperature information of various objects to help a segmentation processing or any other type of processing done on the visible image. This process could even be iterative, in which a first camera is used to improve the output of the second camera, which is then used to further improve the output of the first camera and so on. With the previous example, it could be that the IR image from the IR camera helps a neural network processing the visible image for a better segmentation of the objects, which improves the distance estimations from the same or another neural network, which in turn allows to improve the final output from the processed IR image. The resulting distance-corrected temperature information is hence more accurate than without the processing.

In some embodiments according to the present invention, the output from the camera after processing the visible and the IR images together is a single digital image file in RGBT format. This image format, consisting of 4 channels for the red, green, blue and temperature information in the image, allows for easier exchange of the resulting output from the processor.

In some embodiments according to the present invention, some information is only seen in either the visible or the IR spectral band and cannot be seen in the other spectral band. In that case, the information that can be seen in one of the spectral bands can be used to further improve the output in the other spectral band in which this information cannot be seen.

These examples are not intended to be an exhaustive list or to limit the scope and spirit of the present invention. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An imager configured to capture images of a scene, the imager comprising:
a. an infrared camera creating a digital image with infrared scene information;
b. a visible camera creating a digital image with visible scene information; and
c. a processor configured to process one of the digital image with infrared scene information or the digital image with visible scene information,
wherein the processing by the processor of the one of the digital image with infrared scene information or the digital image with visible scene information is used by the processor to modify an output from the imager related to the other of the digital image with infrared scene information or the digital image with visible scene information.

2. The imager of claim 1, wherein the digital image with visible scene information has a higher number of pixels than the digital image with infrared scene information.

3. The imager of claim 2, wherein additional information from the higher number of pixels from the digital image with visible scene information is used by the processor to modify the digital image with infrared scene information.

4. The imager of claim 1, wherein the infrared camera is used in the Long Wavelength Infrared waveband.

5. The imager of claim 1, wherein the processing by the processor of the one of the digital image with infrared scene information or the digital image with visible scene information calculates a distance of an object in the scene from the imager.

6. The imager of claim 5, wherein the calculated distance is used to modify an output temperature information of the object.

7. The imager of claim 1, wherein the processing by the processor of the one of the digital image with infrared scene information or the digital image with visible scene information is performed with a neural network algorithm.

8. The imager of claim 1, wherein the infrared scene information is used by the processor to modify the digital image with visible scene information.

9. The imager of claim 1, wherein both the infrared camera and the visible camera are located on one physical device.

10. The imager of claim 1, wherein a field of view of the infrared camera and a field of view of the visible camera are greater than 80°.

11. The imager of claim 1, wherein the modified output is displayed on a display.

12. An imager configured to capture images of a scene, the imager comprising:
a. an infrared camera creating a digital image with infrared scene information;
b. a visible camera creating a digital image with visible scene information; and
c. a processor configured to process one of the digital image with infrared scene information or the digital image with visible scene information,
wherein at least one of the digital image with infrared scene information or the digital image with visible scene information has image distortion to create at least one zone of interest, and wherein the processing by the processor of the one of the digital image with infrared scene information or the digital image with visible scene information is used to modify an output from the imager related to the other of the digital image with infrared scene information or the digital image with visible scene information.

13. The imager of claim 12, wherein the digital image with visible scene information has a higher number of pixels than the digital image with infrared scene information and wherein additional information from the higher number of pixels from the digital image with visible scene information is used by the processor to modify the digital image with infrared scene information.

14. The imager of claim 12, wherein the processing by the processor of the one of the digital image with infrared scene information or the digital image with visible scene information calculates a distance of an object in the scene from the imager.

15. The imager of claim 14, wherein the calculated distance is used to modify an output temperature information of the object.

16. The imager of claim 12, wherein the processing by the processor of the one of the digital image with infrared scene information or the digital image with visible scene information is performed with a neural network algorithm.

17. The imager of claim 1, wherein the infrared scene information is used by the processor to modify the digital image with visible scene information.

18. The imager of claim 1, wherein both the infrared camera and the visible camera are located on one physical device.

19. The imager of claim 1, wherein a field of view of the infrared camera and a field of view of the visible camera are greater than 80°.

20. The imager of claim 1, wherein the modified output is displayed on a display.

21. A method for modifying the output from an imager by using visible and infrared scene information, the method comprising the steps of:
a. obtaining a digital image with infrared scene information from an infrared camera;
b. obtaining a digital image with visible scene information from a visible camera; and
c. processing by a processor one of the digital image with infrared scene information or the digital image with visible scene information,
wherein the processing by the processor of the one of the digital image with infrared scene information or the digital image with visible scene information is used to modify an output from the imager related to the other of the digital image with infrared scene information or the digital image with visible scene information.

22. The method of claim 19, wherein the processing by the processor of the one of the digital image with infrared scene information or the digital image with visible scene information calculates a distance of an object in the scene from the imager, the calculated distance being used to modify an output temperature information of the object.
